(19) United States
(12) Patent Application Publication
(10) Pub. No.: US 2019/0039339 A1
(43) Pub. Date: Feb. 7, 2019

(54) DEVICE FOR HEATING A GIVEN ZONE OF A PART

(71) Applicant: Safran Aircraft Engines, Paris (FR)

(72) Inventors: Damien Lamouche, Moissy-Cramayel (FR); Pierre Antoine BOSSAN, Moissy-Cramayel (FR)

(73) Assignee: Safran Aircraft Engines, Paris (FR)

(21) Appl. No.: 15/759,609

(22) PCT Filed: Sep. 13, 2016
(86) PCT No.: PCT/FR2016/052301

§ 371 Date: Mar. 13, 2018

(30) Foreign Application Priority Data
Sep. 14, 2015 (FR) 1558565

(51) Int. Cl. B29C 73/34

(52) U.S. Cl. CPC B29C 73/34; B29L 2031/7504

(57) ABSTRACT

A device for confining a given zone of a part. The device having a first rigid sleeve open to a first end which is capable of being applied around said given zone of the part. The device further having a second flexible and elastic sleeve open to a same first end as the first sleeve and intended to be applied on the part. The second sleeve remotely surrounds the first rigid sleeve so as to form an annular space which is connected to the means for depressing the annular space.

The invention relates to a device for heating a given zone of a part, such as a surface of a turbine engine casing.

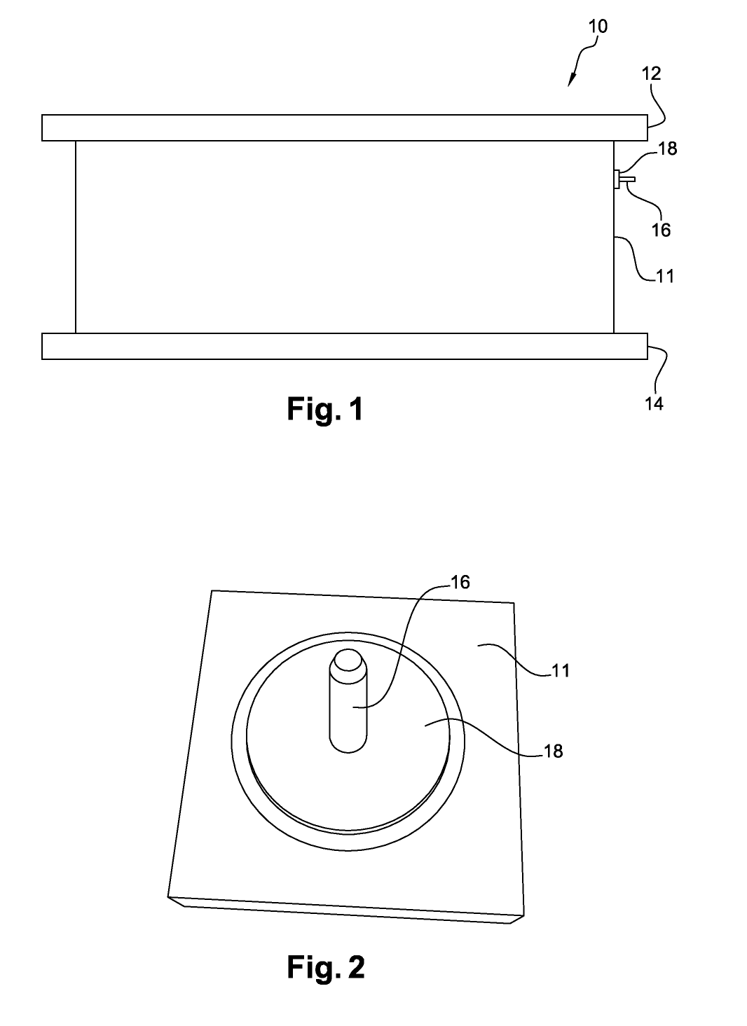

Conventionally, a turbine engine comprises an intermediary casing 10 arranged between a low-pressure compressor and a high-pressure compressor. Such a casing 10 comprises a substantially cylindrical wall 11 extending between an upstream flange 12 and a downstream flange 14, these flanges 12, 14 being used to attach the intermediary casing on the stator parts of the turbine engine (FIGS. 1 and 2).

The outer surface of the wall 11 of the casing is used, in particular, for fastening equipment, a protective thermal shell or ducts for fluid to pass through. In particular, to attach the protective thermal shell, it is known to use threaded rods 16 supported by a baseplate 18 made of carbon composite, the latter being attached on the outer surface of the cylindrical wall 11 of the casing 10 by means of a thermosetting glue. For this, the casing 10 must be placed in a furnace for a determined period beforehand, which can be several hours, which interrupts all subsequent production steps the casing requires. In addition, the movement of an intermediary casing can prove to be delicate to carry out in the case where it has a significant diameter, around one to two metres. In addition, certain equipment cannot be placed in a furnace because of it being too large.

The invention in particular aims to provide a simple, effective and economical solution to this problem.

To this end, it proposes a device for confining a given zone of a part comprising a first rigid sleeve, open at a first end, which is capable of being applied around said given zone of the part and a second flexible and elastic sleeve, open at a same first end as the first sleeve, and intended to be applied on the part, the second sleeve remotely surrounding the first rigid sleeve, so as to form an annular space which is connected to the means for depressing the annular space, when the first ends of the first sleeve and of the second sleeve are applied on the part.

Different from the prior art, the invention enables to apply a confinement device around the part to thus locally heat the part in the place where heating is wanted to be carried out, to carry out, for example, a polymerisation operation of a glue. Thus, heating the whole part is avoided.

The first sleeve enables to confine the part at the level of the zone surrounded by the first end thereof applied on the part. The first sleeve and the second sleeve together defining an annular space which is connected to the means for depressing the annular space, thus enabling the device to be held on the part.

Using a first rigid sleeve enables to keep a fixed, non-deformable volume inside it, enabling the assembly inside the first sleeve or a fastening body on the part. Using a second flexible and elastic sleeve enables to guarantee the heating device is held on the part to be heated, in particular, when the device does not rest on the part to be heated.

The device according to the invention enables, in case of breaking an attachment body on the casing, to repair it quicker, without carrying out a complex disassembly of the engine. A repair under the wing could also be considered, thus avoiding the very expensive engine being dropped.

It will be noted that in the application, the term “annular” used for defining the separation space between the first and second sleeves must be interpreted as being a space which does not necessarily have a circular shape, but which is a space extending between the first and second sleeves over 360°.

According to another characteristic of the invention, the first rigid sleeve is made of a resistive material and is connected to the electrical supply means. The material is, for example, thermosetting.

Again, according to another characteristic of the invention, the first sleeve is covered with a thermally-insulating layer over the face thereof oriented towards the second sleeve, which enables to confine the heat inside the first sleeve. The insulating layer can be made of a thermoset material or of a refractory material.

In an embodiment of the invention, the depressing means comprise a Venturi effect duct comprising a suction orifice fluidly connected to said annular space, so as to be able to apply a depression inside said annular separation space between the first sleeve and the second sleeve.

A locking valve can be arranged at the seal between the duct and the inlet of the annular space in order to guarantee the device is held on the part, by no longer requiring the means for depressing the annular space to function, after a depression has been created in the annular space.

Said first annular end of the first sleeve can comprise means for sealing such a seal.

The device preferably comprises means for measuring the temperature inside the first sleeve, such as a thermocouple probe, in order to control the temperature inside the first sleeve, in real time.

The invention will be best understood, and other details, characteristics and advantages of the invention will appear upon reading the following description, made as a non-exhaustive example, in reference to the appended drawings wherein:

FIG. 1, already defined above, is a schematic representation of a turbine engine intermediary casing of a known type;

FIG. 2, also defined above, is a schematic, perspective view of a fastening body assembled on the outer surface of the casing in FIG. 1;

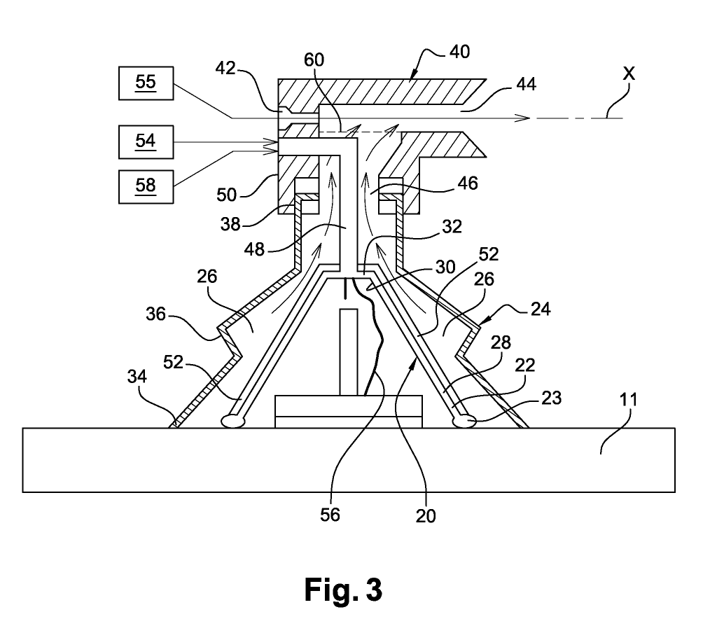

FIG. 3 is a schematic, cross-section view of the heating device according to the invention.

Following the description, FIG. 3 is referred to, which represents a confinement device according to the invention comprising a first space or sleeve 20 comprising a first end 22 applied on the outer surface of the cylindrical wall 11 of the casing 10 defined in reference to FIG. 1. The first sleeve 20 is made of a rigid material, such that it internally defines a non-deformable volume inside which a baseplate 18 can be received, the baseplate 18 being applied on the casing 10 and supporting a threaded rod 16 extending substantially perpendicular to the outer surface 11 of the casing 10. The first rigid sleeve 20 is surrounded externally by a second flexible and elastic sleeve 24. This second sleeve 24 remotely surrounds the first sleeve 20 so as to define an annular space 26 between the first sleeve 20 and the second sleeve 24.

More specifically, the first sleeve 20 comprises an opening at the level of the first annular end 22 thereof, which supports the sealing means such as an annular seal 23 so as to create a sealing support between this first end 22 and the outer surface 11 of the casing 10 whereon the first end 22 of the first sleeve 20 is applied. In the specific embodiment represented in FIG. 3, the first sleeve 20 comprises a truncated section wall 28 flaring in the direction of the first end of the sleeve 20 and is connected at the level of the second end 30 thereof, opposite a second substantially flat wall 32. Thus, in a supporting position on the part 10, the first sleeve 20 forms with the zone of the part surrounded by the first sleeve 20, an enclosed space. Of course, the specific shape of the first sleeve 20 here is dictated by the shape of the baseplate 18 and of the rod 16 and the position wherein this baseplate is wanted to be attached on the casing 10. Thus, the first sleeve 20 can be any shape adapted to an insertion around a given zone to be heated of a part.

The second sleeve 24 also comprises an opening to a first annular end 34 supporting on the outer surface of the cylindrical wall 11 of the casing 10. This second sleeve 24 has a general truncated shape, flaring in the direction of the first end 34 and comprises one or several convex gussets or swellings 36 enabling to facilitate to elastic deformation of the wall thereof. The second sleeve 24 comprises a second end 38 opposite the first end 34 and connected to a duct 40.

The device comprises means for depressing the annular space. In the embodiment represented in FIG. 3, these means comprise a vacuum pump comprising a Venturi effect duct 40 of axis X comprising, at an upstream end, an air inlet orifice 42 of a small diameter and, at a downstream end, an air outlet orifice 44 of a larger diameter. The duct 40 comprises a lateral air suction orifice 46 communicating on the one side with the inside of the duct 40 and on the other side, with the annular separation space 26 of the first sleeve 20 and of the second sleeve 24.

As can be seen in FIG. 2, the flat wall 32 of the first sleeve 20 is connected to a supporting arm 48, passing with clearance the suction orifice 46 and inserted into a support 50 connected to the duct 40. The truncated wall 28 of the first sleeve 20 is covered with a thermally-insulating layer 52 over the face thereof oriented towards the second sleeve 24, which enables to confine the heat from the thermal radiation emitted by the first sleeve 20 inside it. The insulating layer 52 can be made of thermoset or of refractory material.

In an embodiment of the invention, the first sleeve 20 and the supporting arm 48 are made of a resistive material and are connected to the electrical supply means 54. The resistive material is, for example, made of a thermosetting material.

The second end 38 of the second sleeve 24 is attached in the support 50 which surrounds the air suction orifice 46.

When functioning, sending a pressurised air flow 55 through the inlet orifice 42 leads to a suction of air from the annular space 26 which exits through the outlet orifice 44 of the duct 40. The reduction in pressure in the annular space 26 thus enables a sealing application of the first sleeve 20 and of the second sleeve 24 on the casing 10.

The device also comprises means for measuring the temperature inside the first sleeve. These means comprise, for example, a thermocouple probe 56 arranged inside the first sleeve 20 and connected externally to the means for processing and displaying the temperature 58. The device can also comprise a check valve 60 arranged, for example, at the level of the suction orifice, so as to maintain the depression in the annular space 26 when it is created by the vacuum pump.

1. A device for confining a given zone of a part, comprising a first rigid sleeve open to a first end which is capable of being applied around said given zone of the part and a second flexible and elastic sleeve open to a same first end as the first rigid sleeve and intended to be applied on the part, the second flexible and elastic sleeve remotely surrounding the first rigid sleeve so as to form an annular space which is connected to a means for depressing the annular space when the first end of the first rigid sleeve and the first end of the second flexible and elastic sleeve are applied on the part.

2. The device according to claim 1, wherein the first rigid sleeve is made of a resistive material and connected to an electrical supply means.

3. The device according to claim 1, wherein the first rigid sleeve is covered with a thermally-insulating layer over a face thereof oriented towards the second flexible and elastic sleeve.

4. The device according to claim 1, wherein the means for depressing comprise a Venturi effect duct fluidly connected to said annular space.

5. The device according to claim 4, wherein a locking valve is arranged between the duct and an inlet of said annular space.

6. The device according to claim 1, wherein said first annular end of the first rigid sleeve supports a means for sealing.

7. The device according to claim 1, comprising means for measuring a temperature inside the first sleeve.

8. The device according to claim 6, wherein the means for sealing comprises a seal.

9. The device according to claim 7, wherein the means for measuring a temperature comprises a thermocouple probe.
